(19) United States
(12) Patent Application Publication
(10) Pub. No.: US 2012/0090178 A1
(43) Pub. Date: Apr. 19, 2012

(54) Thermoplastic/Thermoset Dental Restorative Prosthetics

(75) Inventor: Steven D. Jensen, South Jordan, UT (US)

(73) Assignee: CAO Group, Inc., West Jordan, UT (US)

(21) Appl. No.: 13/333,880

(22) Filed: Dec. 21, 2011

Related U.S. Application Data
(63) Continuation of application No. 12/396,438, filed on Mar. 2, 2009, now abandoned.
(60) Provisional application No. 61/033,377, filed on Mar. 3, 2008.

(51) Int. Cl. A61C 13/00

(52) U.S. Cl. 29/896.1

(57) ABSTRACT

The present invention is dental prosthetics manufactured from polymers rather than ceramics. Various plastics are disclosed for use in making said prosthetics, as are techniques for improving plastic performance in the prosthetics. The prosthetics are first injection molded into pre-set blocks for use in milling machines that dentists use or custom fit prosthetics with less wait time and less cost. Alternatively, an electronic model may be produced using image scanners. The electronic model may then be downloaded into rapid prototyping machine and a prosthetic therein built. Use of these methods may create various monolithic prosthetics, including multi-tooth prosthetics and whole bridges.

### TECHNICAL FIELD OF THE INVENTION

The present invention relates to the field of dentistry and more particularly relates to dental prosthetics.

### CROSS-REFERENCE TO RELATED APPLICATION

This application claims benefit of U.S. patent application Ser. No. 12/396,438, filed on Mar. 2, 2009, which claims benefit of U.S. Provisional Application No. 61/033,377, filed Mar. 3, 2008, both of which are incorporated herein by reference in their entirety.

### BACKGROUND OF THE INVENTION

The standard procedure for creating porcelain restorations among the majority of dentists today consists of:

1. taking an accurate impression with polyvinyl siloxane elastomeric impression material;

2. creating a casting of the impression with dental stone (gypsum); and

3. sending the related castings out to an independent lab that creates the porcelain prosthetics.

This process usually takes days to weeks before a final prosthetic can be cemented into the patient's mouth. The patient in the interim must be fitted with a temporary appliance cemented in with temporary cement. A second appointment is made and upon return the temporary crown is removed and the cement is arduously cleaned off the tooth, at which point the final prosthetic can be cemented and fitted into place. Without an alternative procedure to replace this standard practice, the current procedure creates many problems:

1. Scheduling conflicts—The dentist must coordinate the return of the prosthetic from the lab and the patients' busy schedule.

2. The dentist is totally reliant on an independent lab for a successful outcome.

3. The days to weeks delay and the often poor fitting temporary appliances allows the teeth to move during the interim period, therefore the dentist usually has to adjust the prosthetic before fit and bite are adjusted properly.

4. Complete removal of residual temporary cement is near impossible resulting in sometimes-lower adhesive strengths with the final cementation.

Recent advances in dentistry allow dentists to make porcelain restorations without sending an impression to a lab. Recent advances in CAD/CAM and mini-CNC technology have begun to make an impact on the customary process for creating prosthetics. These new advances obsolete many of the frustrations created by the old process. The entire prosthetic manufacturing can be done in the dental office and on the same day. The process usually consists of:

1. taking a 3D image of the treatment area with a sophisticated camera and software system either intra-oral or on a plaster (or other similar material) mold previously taken according to the methods described above;

2. using CAD software to design the desire prosthesis;

3. downloading the resulting file to a small milling machine in which is loaded a precast block of consumable porcelain;

4. using the mill to carve the appropriate prosthetic; and

5. cementing the resulting final prosthetic into the patient on the same day.

This newer process obsoletes impression materials, dental stone, second appointments, temporary prosthetics, temporary cements and independent labs all present in the first, older, method described above. Obviously these advantages have dentists moving toward these new technologies. This has opened up a new market for the consumable components that service these milling machines. Many companies today make porcelain blocks of various compositions that fit into these milling machines. It should be understood that “porcelain” is a ceramic including oxides of aluminum, silicon, and mineral combinations of these elements.

A variety of prosthetic materials are vying for supremacy, the industry and dentist both desiring the optimum characteristics of the prosthetic. The longevity and endurance of the prosthetic installed in the patient being a paramount factor for the dentist. A cracked, de-laminated, broken or chipped prosthetic results in a phone call from an annoyed patient and a replacement prosthetic usually at the dentists cost. Therefore the need for improved prosthetic materials is essential to the success of a modern dental office.

The ceramic materials also include a variety of minerals including lead and mercury, which cause sensitivity and toxicity for different patients.

This patent has to do with improved materials and methods of manufacturing of dental prosthetics. The majority of the materials used in current practice usually consist of:

1. Porcelain fused to metal prosthetics.

2. All porcelain prosthetics.

3. Porcelain laminated to Alumina prosthetics.

4. Porcelain laminated to Zirconia Prosthetics.

Independent labs are usually capable of producing all of the above listed prosthetics with the all porcelain prosthetics being the only choice for in-office milling machines. These materials offer various advantages and disadvantages. The ideal characteristics warranted in these materials usually consist of:

1. Strength and toughness—a resistance to tensile, compressive and shear forces.

2. Fracture toughness—a resistance to cracks and crack propagation and chips that eventually results in overall failure

3. Lamination integrity—A resistance to de-lamination of 2 or more materials bonded together.

4. Wear resistance—A resistance to friction wear due to daily and expected use of the material.

5. Toxicity—minerals in the ceramics may result in sensitivity and toxicity for patients.

The above factors are the predominate issues that weigh the most heavily in current materials of choice. There are other minor characteristics to examine in these materials, but do not become an issue since the dominant issues have yet to be solved. These issues plague the current array of materials used today. A recent study of prosthetic materials have shown defects such as chips, cracks, de-laminations and complete failures in these prosthetics as high as 70% after 2 years. The materials of choice today have leaned toward inorganic ceramics/porcelains. Ceramics are very hard and strong. The hardness of these materials means they are also brittle. Unfortunately, being ceramic, ceramic prosthetics behave similar to glass. A single chip or micro-fracture will eventually lead to complete failure. This is similar to a small chip in a glass windshield that eventually results in a large crack. Ceramics/Porcelains have good strength, toughness, and wear resistance; but have poor fracture resistance. Once ceramics/porcelains acquire a defect, even if the defect is very small they will eventually crack and fail Milling ceramics, like porcelain, is also very expensive and difficult, requiring expensive tooling and causing extreme wear on those tools. There is also the inherent risk of fracture during the milling process. Due to the difficulties inherent in milling ceramics, there is no capability of milling anything but a single tooth. Multi-tooth, monolithic appliances are all but impossible to create. What are needed are prosthetics made from non-laminated materials with good strength, toughness, wear resistance and especially fracture resistance. The prosthetics also need to be made from a material that will not fail due to a small defect and will resist fracture propagation.

The technology of the present invention comprises novel materials and an expedited means of manufacture. These new materials depart from the prior art in that they incorporate organic materials; more specifically they encompass organic polymers. These polymers selected from the group that best impart the essential characteristics warranted for dental prosthetics. Furthermore, the ideal polymer should be capable of being moldable; more specifically they encompass materials that are capable of being injection moldable.

The present invention represents a departure from the prior art in that the prosthetics of the present invention utilize organic plastics which are durable and permanent, while also being fashioned in the dentist's office for same day installation in a patient.

### SUMMARY OF THE INVENTION

In view of the foregoing disadvantages inherent in the known types of dental prosthetics, this invention provides rapid generation of customizable plastic dental prosthetics. As such, the present invention's general purpose is to provide a new and improved dental prosthetics that are inexpensive and simple to manufacture in a dental office while also providing the durability and extended life span of a truly permanent dental prosthetic.

The present invention incorporates the use of high strength plastics that are capable of being easily and quickly molded by machines. The industry of molding plastics/polymers into a pre-designed shape is well known. The process produces large quantities of reproducible parts at economical prices. The latest advances in polymer chemistry have resulted in plastics with high strength, wear resistance and fracture resistance. These new plastics cannot only be made into dental prosthetic, but also, with new small-scale manufacturing techniques, be made on site in a dental office for immediate use in a patient.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DETAILED DESCRIPTION OF THE INVENTION

Plastics have an ability to be strong and deform without fracturing under stress. This inherent ability of some polymers to deform (flex/stretch) instead of fracturing is ideal for a prosthetic dental material. Even plastics that are brittle can be modified by plasticizers to impart more elasticity to the polymer in order to make them useful as an ideal prosthetic material. Usable plastics can be a thermoplastic or a thermoset plastic. These polymers can be comprised of straight chain, co-polymeric, block or any combination of polymers incorporated into the same mass. Plastics can be chosen from the group of polymers such as: polyacrylates, polyamide-imide, phenolic, nylon, nitrile resins, fluoropolymers, copolyvidones (copovidones), epoxy, melamine-formaldehyde, diallyl phthalate, acetal, coumarone-indene, acrylics, acrylonitrile-butadiene-styrene, alkyds, cellulosics, polybutylene, polycarbonate, polycaprolactones, polyethylene, polyimides, polyphenylene oxide, polypropylene, polystyrene, polyurethanes, polyvinyl acetates, polyvinyl chloride, poly(vinyl alcohol-co ethylene), styrene acrylonitrile, sulfone polymers, saturated or unsaturated polyesters, urea-formaldehyde, or any like or useful plastics. Currently, the preferred plastics of the present invention include: Poly ether ether ketone (PEEK), Hi-lubricity nylons, impact resistant polymethylmethacrylate and fluoro-polymers. These polymers are high strength plastics that are resistant to wear and fracturing. They are also resistant to moisture and chemicals. The preferred plastic would also be selected from the group of thermoplastics that are capable of being injection molded, such that the entire polymer block and insert that loads into the dental milling machine can be injection molded completely. It is also possible for the block to be made of a polymer and injection molded onto a metal insert; the metal insert being loaded into the milling machine in order to hold the polymer block for milling.

Various polymers can also be modified in order to maximize the warranted characteristics for a dental prosthetic. This usually means incorporating the addition of a plasticizer or filler into the plastic. Plasticizers usually impart more elasticity to the polymer, therefore rendering them more resilient. A few examples of possible plasticizers include mineral oil, triethyl citrate, acetyltriethyl citrate, lauric acid, modified vegetable oils, diacetylated monoglycerides, castor oil, sucrose diacetate hexaisobutyrate, triacetin, glycerin, liquid polyethylene glycols, liquid poly propylene glycols, propylene glycol, dimethyl phthalate, diethyl phthalate, dipropyl phthlate, dibutyl phthalate, dioctyl phthalate, polysorbates or any like or useful plasticizer.

Fillers can also be incorporated into the plastic. Fillers usually modify the wear resistance, elasticity, fracture toughness and strength of the plastic. A filler can be comprised of either powder or fiber, such as pieces of monofilament. A few examples of possible fillers would be silica, silica carbide, plastic monofilaments, carbon fiber, zirconia, alumina, borosilicate glass powder, radiopaque borosilicate powder, other radiopaque substances, titanium dioxide, zinc oxide, pigments, or any like or useful filler.

The plastic, filler and plasticizer can be adjusted to impart essential characteristics to polymers that may be otherwise questionable as a useful dental prosthetic material. Pigments may also be added in order to manufacture all the shades needed to match the teeth of the human race.

The polymers used in the present invention are loaded and melted in an injection molding machine that reproduces a block that fits into the dental milling machine. The mold may incorporate inserts and base prosthetics into itself. Since the block is molded for the milling machine, only one mold, or a series of standard interchangeable molds for size, are necessary, keeping costs lower. The mold is then subsequently cooled and the solidified block is released from the mold. Blocks are then sold to dentists in various shades and sizes. As used in this specification, the term “block” may be any shape, including cubes, spheres or round and polyhedral cylinders, and mayor may not include a protruding end to fit in some milling machines. The protruding end may be of the same material as the block or may be an inserted post made of metal or some other material. The dentist then selects and inserts the finished polymer block into the milling machine and the polymer block is milled into a prosthetic, similar to the milling of porcelain prosthetics. The milled prosthetic is then fitted and cemented permanently into place on the same day as the initial visit. Polymer prosthetics such as a crown, bridge, inlay, or onlay can be milled from these polymer blocks. The technology of the present invention is compatible with rapid prototyping equipment that would be near impossible for the technology of the prior art. Ceramics and porcelain melt at over 1000 C and are therefore confined for use in a furnace. The plastics of the present invention melts at much lower temperatures such that they could be used in commercial rapid prototyping machines. There are various types and methods of rapid prototyping technologies available that could be customized to build the prosthetics of the present invention. Examples of Rapid Prototyping technologies include but are not limited to: Selective Laser Sintering (SLS), Fused Deposition Modeling (FDM), Laminated Object Manufacturing (LaM), 3D Printing (3DP), Stereolithography (SLA), Electron Beam Melting (EBM), and any like method or device. An example of integrating the technology of the present invention with a rapid prototype device utilizing the Fused Deposition Modeling (FDM) technology is forthwith given, it is to be understood that this description is exemplary and each method, including future prototyping methods, may be used in the present invention. Fused Deposition Modeling is an additive process that successively builds an engineered construct that is pre-designed through modeling software such as computer aided design programs (CAD). One such device uses a polymer to create the body of the construct, said polymer delivered as a plastic feed wire. The plastic feed wire is directed to a heated nozzle that melts the plastic and controls the delivery of the molten plastic during the additive build-up process. Following the design being downloaded from the CAD software, the nozzle or the platform will usually move with respect to an X, Y and Z axis of the Cartesian coordinates; the construct being built between the platform and the nozzle. The heated plastic ultimately flows out the nozzle onto the platform at precise times and coordinates in a single layer or strand that quickly cools. This solid layer is then successively built upon with additional strands or layers into a designed construct. By this method crowns, inlays, onlays, dentures and bridges can be constructed. Plastics of the present invention could therefore be incorporated into (FDM) technology to build prosthetics for dental, medical or veterinary use. Rapid prototype technology coupled with imaging scanners offer an even greater advantage over the prior art. Image scanners would be utilized to capture a 3D image of the treatment area and, through the use of additional modeling software, create a custom image of the desired prosthetic for download, a model that would more precisely fit the treatment area. Commercially available milling machines are only capable of milling small prosthetics such as a crowns, inlays or onlays. The technology of the present invention coupled with rapid prototype devices and image scanners would allow larger prosthetics such as custom bridges, bones and dentures that are not manufacturable by prior art milling machines. The general process for the preferred method usually comprising:

1. A 3D scanner scans the anatomical surfaces of the area to be treated.

2. Said image is then manipulated into a desired prosthetic model by modeling software.

3. The final image model downloaded to the rapid prototype device wherein the plastic of the present invention is incorporated.

4. The rapid prototyping device is then activated and successively constructs the prosthetic by the additive process.

5. The finished prosthetic is then polished and cemented into place; optionally correcting any abnormal anatomy if necessary.

From this example other rapid prototyping devices, machines, procedures and methods could be utilized to build prosthetics of the present invention for physiological use; whether they utilize: additive, curing, vaporization, subtractive, and/or any other rapid prototyping method.

It is also possible to a produce an entire denture appliance by this method. The present technology also provides means for improved prosthetics and appliances that result in less failure; this in turn results in less return visits by the patients.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method of creating a prosthetic comprising:
molding a plastic into a block suitable for milling, said block for milling having sufficient body that through the milling process a prosthetic is capable of creation;
milling said polymer or plastic body into a prosthetic;
wherein the prosthetic is placed into a body for physiological use.
